(19) United States
(12) Patent Application Publication
(10) Pub. No.: US 2019/0237034 A1
(43) Pub. Date: Aug. 1, 2019

(54) DISPLAY PANEL AND LIQUID CRYSTAL DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Sikun HAO, Shenzhen (CN)

(21) Appl. No.: 16/023,636

(22) Filed: Jun. 29, 2018

Related U.S. Application Data
(63) Continuation of application No. PCT/CN2018/078157, filed on Mar. 6, 2018.

(30) Foreign Application Priority Data
Jan. 26, 2018 (CN) 201810082874.4

(51) Int. Cl. G09G 3/36

(52) U.S. Cl. CPC G09G 3/3677; G09G 2300/0809; G09G 3/3614

(57) ABSTRACT

A display panel and liquid crystal display device are disclosed. The display panel includes: multiple sub-pixel units are arranged as an N×M matrix; a i-th gate line respectively connected to the sub-pixel units of (2i−1)-th row and the sub-pixel units of (2i)-th row; and a (2j−1)-th source line respectively connected to the sub-pixel units of j-th column and a first row, and a 2j-th source line respectively connected to the sub-pixel units of j-th column and a second row. The present invention can increase the charging rate, and reduce the number of the gate lines and source lines to save cost.

### CROSS REFERENCE

This application is a continuing application of PCT Patent Application No. PCT/CN2018/078157, entitled “Display panel and Liquid crystal display device”, filed on Mar. 6, 2018, which claims priority to China Patent Application No. CN 201810082874.4 filed on Jan. 26, 2018, both of which are hereby incorporated in its entireties by reference.

### FIELD OF THE INVENTION

The present invention relates to an electric circuit technology field, and more particularly to a display panel and a liquid crystal display device.

### BACKGROUND OF THE INVENTION

A liquid crystal display device is the most widely used flat display device, and has become a color screen display device with high resolution applied in various electric equipment such as mobile phones, personal digital assistants (PDAs), digital cameras, computer screens or laptops. Currently, the driving structure of the liquid crystal display device has two types. As shown in FIG. 1A and FIG. 1B, one type is a Tri-gate driving structure, the other type is a Normal driving structure. As shown, the number of the gate lines of the Tri-gate driving structure is ⅓ of the number of the gate lines of the Normal driving structure, and the number of the source lines of the Tri-gate driving structure is three times of the number of the source lines of the Normal driving structure. The both driving structures have their own advantages and disadvantage. The number of the gate lines of the Normal driving structure is too much such that more gate driving circuit is required. The number of the source lines of the Tri-gate driving structure is too much such that more layout space is required for the source driving chip. In the research, effective mechanism for solving the above problem is insufficient so that the quality of the liquid crystal display device cannot be further improved.

### SUMMARY OF THE INVENTION

The embodiment of the present invention provides a display panel and a liquid crystal display device. The embodiment of the present invention can improve a charging rate, and reduce the number of the gate lines and source lines to save the cost.

In a first aspect, the present invention provides a display panel, comprising: multiple sub-pixel units are arranged as an N×M matrix; a i-th gate line respectively connected to the sub-pixel units of (2i−1)-th row and the sub-pixel units of (2i)-th row; and a (2j−1)-th source line respectively connected to the sub-pixel units of j-th column and a first row, and a 2j-th source line respectively connected to the sub-pixel units of j-th column and a second row, wherein the sub-pixel units of the first row is one row of the sub-pixel units of a (2k−1)-th row and (2k)-th row, and the sub-pixel units of the second row is the other row of the sub-pixel units of (2k−1)-th row sub-pixel units and (2k)-th row; wherein each of N, M, I, j, k is a positive integer, i and k are not greater than N/2+1, j is not greater than M.

Combining the first aspect and some possible embodiment ways, the (2j−1)-th source line is respectively connected with the sub-pixel units of odd rows of j-th column, and the (2j)-th source line is respectively connected with the sub-pixel units of even rows of j-th column; or, the (2j−1)-th source line is respectively connected with the sub-pixel units of even rows of j-th column, and the (2j)-th source line is respectively connected with sub-pixel units of odd rows of j-th column.

Combining the first aspect and some possible embodiment ways, each sub-pixel unit of a (3a+1)-th row is a red sub-pixel unit, each sub-pixel unit if a (3a+2)-th row is a green sub-pixel unit and each sub-pixel unit of a (3a+3)-th row sub-pixel unit is a blue sub-pixel unit, wherein a is a non-negative integer not greater than N/3.

Combining the first aspect and some possible embodiment ways, a signal polarity of a (4b+1)-th source line and a (4b+2)-th source line is a first polarity, and a signal polarity of a (4b+3)-th source line and a (4b+4)-th source line is a second polarity, b is a non-negative integer not greater than M/2.

Combining the first aspect and some possible embodiment ways, each sub-pixel unit includes a thin-film transistor TFT, a liquid crystal capacitor, and a storage capacitor.

In a second aspect, the present invention provides a display device including a display panel and display device body, wherein display panel comprises: multiple sub-pixel units are arranged as an N×M matrix; a i-th gate line respectively connected to the sub-pixel units of (2i−1)-th row and the sub-pixel units of (2i)-th row; and a (2j−1)-th source line respectively connected to the sub-pixel units of j-th column and a first row, and a 2j-th source line respectively connected to the sub-pixel units of j-th column and a second row, wherein the sub-pixel units of the first row is one row of the sub-pixel units of a (2k−1)-th row and (2k)-th row, and the sub-pixel units of the second row is the other row of the sub-pixel units of (2k−1)-th row sub-pixel units and (2k)-th row; wherein each of N, M, I, j, k is a positive integer, i and k are not greater than N/2+1, j is not greater than M.

Combining the second aspect and some possible embodiment ways, the (2j−1)-th source line is respectively connected with the sub-pixel units of odd rows of j-th column, and the (2j)-th source line is respectively connected with the sub-pixel units of even rows of j-th column; or, the (2j−1)-th source line is respectively connected with the sub-pixel units of even rows of j-th column, and the (2j)-th source line is respectively connected with sub-pixel units of odd rows of j-th column.

Combining the second aspect and some possible embodiment ways, each sub-pixel unit of a (3a+1)-th row is a red sub-pixel unit, each sub-pixel unit if a (3a+2)-th row is a green sub-pixel unit and each sub-pixel unit of a (3a+3)-th row sub-pixel unit is a blue sub-pixel unit, wherein a is a non-negative integer not greater than N/3.

Combining the second aspect and some possible embodiment ways, a signal polarity of a (4b+1)-th source line and a (4b+2)-th source line is a first polarity, and a signal polarity of a (4b+3)-th source line and a (4b+4)-th source line is a second polarity, b is a non-negative integer not greater than M/2.

Combining the second aspect and some possible embodiment ways, each sub-pixel unit includes a thin-film transistor TFT, a liquid crystal capacitor, and a storage capacitor.

Through the embodiment of the present invention, one gate line is connected with two rows of the sub-pixel units so as to save the gate lines, reduce the layout space of the driving circuit such that the width of the edge frame can be reduced. Besides, the charging time of the sub-pixel unit when driving the display panel in a frame signal is doubled in order to increase the charging rate.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1A is a schematic diagram of a Normal driving structure of the conventional art;

FIG. 1B is a schematic diagram of a Tri-gate driving structure of the conventional art;

FIG. 2 is a schematic diagram of a display panel according to an embodiment of the present invention; and

FIG. 3 is a schematic diagram of a portion region of a display panel according to an embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

The terminology used herein is for the purpose of describing particular example embodiments only and is not intended to be limiting. As used herein, the singular forms “a,” “an,” and “the” may be intended to include the plural forms as well, unless the context clearly indicates otherwise

It can be understood that in the specification and claims of the present invention, the terms and/or indicates one or more of any combination or all possible combination in the related terms being listed, and including the above combinations.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In the embodiment of the present invention, the display panel is mainly used in a liquid crystal display screen, wherein the operation principle is: liquid crystals are such organic compounds that exhibit the fluidity of both the liquid and the optical anisotropy of the crystal at room temperature, and are thus called “liquid crystals”. Under the influence of external conditions such as electric field, magnetic field, temperature, and stress, the molecules are easily rearranged to change the optical properties of the liquid crystal. The anisotropy of the liquid crystal and its molecular arrangement are susceptible to the applied electric field and magnetic field. It is to use the physical basis of this liquid crystal, that is, the “electro-optical effect” of the liquid crystal to realize that the light is modulated by an electric signal, thereby making a liquid crystal display device. Under the action of different current electric fields, the liquid crystal molecules will be regularly rotated by 90 degrees to produce a difference in transmittance. This will produce a difference between light and dark when the power is turned ON/OFF. By controlling each pixel according to this principle, the desired image can be constructed. In the embodiment of the present invention, the display panel is mainly used to control the rotation angle of the liquid crystal, so as to control each pixel to form an image.

In the embodiment of the present invention, the display panel includes multiple sub-pixel units, multiple gate lines and multiple source lines. Wherein, the sub-pixel unit is used to control a rotating angle of the liquid crystal molecules under the control if the signal outputted by the source line. The gate line is also known as a scan line for receiving the signal outputted from the source line, the source line is also known as a data line for control the sub-pixel unit to generate a voltage. In a practical application, a gate line output a turning-on signal to control a row of the sub-pixel unit to turn on such that the sub-pixel unit receives the signal outputted from the source line. Then, another gate line output a turning-on signal to control another row of the sub-pixel unit to turn on such that the sub-pixel unit receives the signal outputted from the source line. Accordingly, all sub-pixel units receive a control.

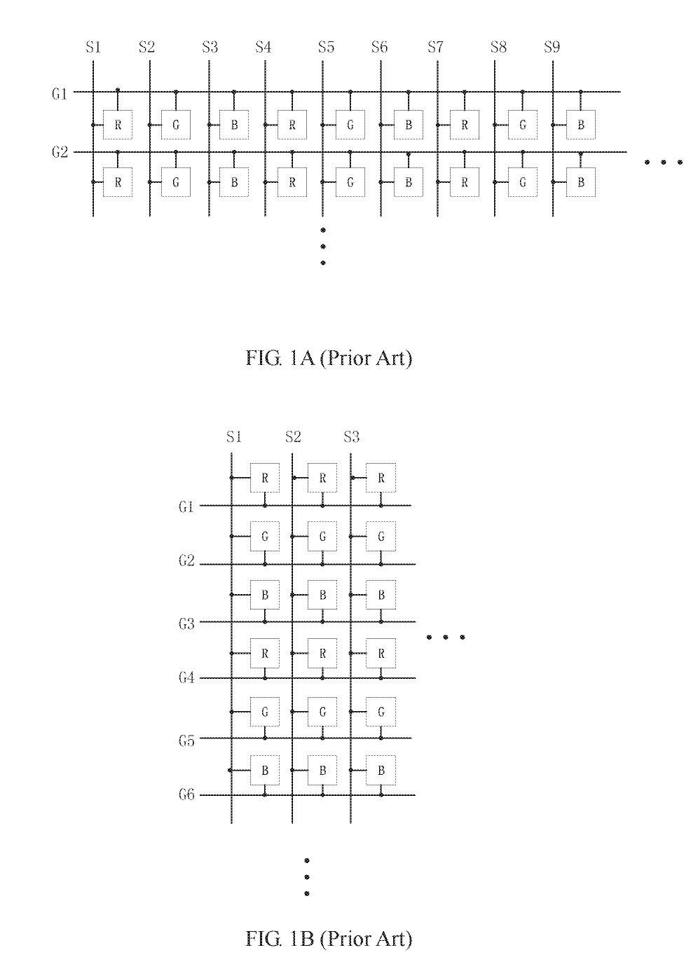

As shown in FIG. 1A and FIG. 1B, one type is a Tri-gate driving structure, the other type is a Normal driving structure. As shown, the number of the gate lines of the Tri-gate driving structure is ⅓ of the number of the gate lines of the Normal driving structure, and the number of the source lines of the Tri-gate driving structure is three times of the number of the source lines of the Normal driving structure. The both driving structures have their own advantages and disadvantage. The number of the gate lines of the Normal driving structure is too much such that more gate driving circuit is required. The number of the source lines of the Tri-gate driving structure is too much such that more layout space is required for the source driving chip. In the research, effective mechanism for solving the above problem is insufficient so that the quality of the liquid crystal display device cannot be further improved. For the display panel provided by the embodiment of the present invention, same number of the sub-pixel unit has less source line than the Normal driving structure, and less gate line than the Tri-gate driving structure.

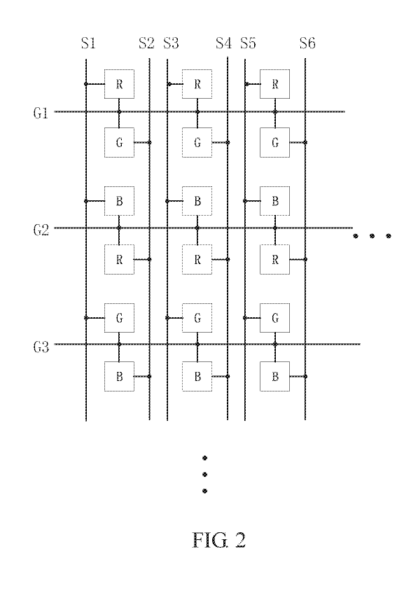

With reference to FIG. 2, FIG. 2 is a schematic diagram of a display panel according to an embodiment of the present invention. As shown in FIG. 2 the display panel of the embodiment of the present invention includes: multiple sub-pixel units, multiple gate lines and multiple source lines.

In the present embodiment, the sub-pixel units are arranged as an N×M matrix. Between every two rows of the sub-pixel units, a gate line is provided. Two sides of each column of the sub-pixel units are respectively provided with a source line such that the display panel has ┐N/2┌ gate lines and 2M source lines. Wherein, “┐ ┌” is a ceiling function symbol. It can be understood that when the number of the rows of the sub-pixel units is odd-numbered, the number of the source lines is rounded off N/2 to the nearest integral and adding 1. For example, for three rows of the sub-pixel units, 2 gate lines are required.

Furthermore, a connection way among the sub-pixel units, the gate lines and the source lines is: i-th gate line is respectively connected to sub-pixel units of (2i−1)-th row and sub-pixel units of (2i)-th row. A (2j−1)-th source line is respectively connected to sub-pixel units of j-th column and a first row. A 2j-th source line is respectively connected to sub-pixel units of j-th column and a second row. Wherein, the sub-pixel units of the first row is one row of the sub-pixel units of a (2k−1)-th row and (2k)-th row, the sub-pixel units of the second row is the other row of the sub-pixel units of (2k−1)-th row sub-pixel units and (2k)-th row wherein, each of N, M, I, j, k is a positive integer, i and k are not greater than N/2+1, j is not greater than M.

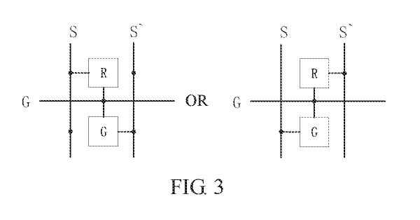

For understanding, the display panel described above can be resolved as a small block shown in FIG. 3. The small block includes two sub-pixel units, a gate line and two source lines, wherein, the gate line is connected with two sub-pixel units, the two source lines are respectively connected to the two sub-pixel units. In the display panel described above, many small blocks are existed. The specific embodiment method that the two source lines are respectively connected with the two sub-pixel units is not specifically limited. In the small block, one sub-pixel unit corresponds to one source line.

Of course, the connection way of the source line and the sub-pixel unit is regular. For example, in a first way, as shown in FIG. 2, (2j−1)-th source line is respectively connected with sub-pixel units of odd rows of j-th column, and (2j)-th source line is respectively connected with sub-pixel units of even rows of j-th column. Or, in a second way, (2j−1)-th source line is respectively connected with sub-pixel units of even rows of j-th column, and (2j)-th source line is respectively connected with sub-pixel units of odd rows of j-th column. As shown in the small block shown in FIG. 3, the first way indicates that a left side source line and the sub-pixel unit of the first row are electrically connected, and the right side source line and the sub-pixel unit of the second row are electrically connected. The second way indicates that the left side source line and the sub-pixel unit of the second row are electrically connected, and the right side source line and the sub-pixel unit of the first row are electrically connected. It should be noted that all small blocks in the display panel meet the first way and the second way.

In the embodiment of the present invention, because a liquid crystal molecule has a property that the liquid crystal molecule will be damaged if being applied with a fixed voltage for a long time, the polarity inversion of the voltage outputted from the source lines is required to avoid the liquid crystal molecule from being broken. In the polarity inversion process, signal polarities received by a same sub-pixel unit in one frame and a next frame are opposite. The arrangement of the polarities of the sub-pixel unit includes but not limited to: a frame inversion method, a row inversion method, a column inversion method and a dot inversion method. Wherein, after an end of writing of the one frame and before a start of writing of the next frame, for the frame inversion, the voltage polarities stored on the sub-pixel units of whole frame are the same. For the row inversion method, the voltage polarities stored on the sub-pixel units of a same row are the same, and the voltage polarities stored on the sub-pixel units of a next row are the opposite. For the column inversion, the voltage polarities stored on the sub-pixel units of a same column are the same, and the voltage polarities stored on the sub-pixel units of a next column are the opposite. For the dot inversion, for each pixel unit, voltage polarities stored on an above, a below, a left and a right adjacent sub-pixel units are opposite.

Furthermore, the signal polarity outputted from the source lines and the voltage polarity stored on the sub-pixel unit is related. For a column inversion, a signal polarity of a (4b+1)-th source line and a (4b+2)-th source line is a first polarity, and a signal polarity of a (4b+3)-th source line and a (4b+4)-th source line is a second polarity. For a dot inversion, a signal polarity of a (4b+1)-th source line and a (4b+4)-th source line is a first polarity, and a signal polarity of a (4b+2)-th source line and a (4b+3)-th source line is a second polarity. Wherein, the first polarity is one of a positive polarity or negative polarity, and the second polarity is the other of the positive polarity or the negative polarity, and b is a non-negative integer not greater than M/2.

In the present embodiment, the sub-pixel unit can include: a thin-film transistor TFT, a liquid crystal capacitor, a storage capacitor. Wherein, the thin-film transistor is used for receiving a control of the output signal of the gate line and receiving the output signal of the source line. The liquid crystal capacitor is used to rotate liquid crystal molecules; the storage capacitor is used to maintain the stored voltage. Furthermore, the color displayed by the sub-pixel unit can be color or black and white, which is not limited here. When the sub-pixel unit is used for displaying three primary colors of red, green and blue, the following arrangements are included but not limited: each sub-pixel unit of a (3a+1)-th row is a red sub-pixel unit, each sub-pixel unit if a (3a+2)-th row is a green sub-pixel unit and each sub-pixel unit of a (3a+3)-th row sub-pixel unit is a blue sub-pixel unit; each sub-pixel unit of a (3a+1)-th row is a blue sub-pixel unit, each sub-pixel unit of a (3a+2)-th row is a green sub-pixel unit and each sub-pixel unit of a (3a+3)-th row is a red sub-pixel unit; each sub-pixel unit of a (3a+1)-th row is a red sub-pixel unit, each sub-pixel unit of a (3a+2)-th row is a blue sub-pixel unit and each sub-pixel unit of a (3a+3)-th row is a green sub-pixel unit.

It can be understood that in the embodiment of the present invention, the description of the display panel is mainly based on row and column method. If the sub-pixel units are changed in row and column, the gate line and the source line should be adjusted correspondingly, and should be one of the embodiments of the present invention. Besides, the example in the embodiment of the present invention is only used for illustration, and should not be understood as a specific limitation.

The embodiment of the present invention also provides with a liquid crystal display device. With reference to FIG. 1 and FIG. 2, the liquid crystal display device includes a display panel and display device body. Wherein the display panel includes following elements: multiple sub-pixel units, multiple gate lines and multiple source lines.

In the present embodiment, the sub-pixel units are arranged as an N×M matrix. Between every two rows of the sub-pixel units, a gate line is provided. Two sides of each column of the sub-pixel units are respectively provided with a source line such that the display panel has ┐N/2┌ gate lines and 2M source lines. Wherein, “┐ ┌” is a ceiling function symbol. It can be understood that when the number of the rows of the sub-pixel units is odd-numbered, the number of the source lines is rounded off N/2 to the nearest integral and adding 1. For example, for three rows of the sub-pixel units, 2 gate lines are required.

Furthermore, a connection way among the sub-pixel units, the gate lines and the source lines is: i-th gate line is respectively connected to sub-pixel units of (2i−1)-th row and sub-pixel units of (2i)-th row. A (2j−1)-th source line is respectively connected to sub-pixel units of j-th column and a first row. A 2j-th source line is respectively connected to sub-pixel units of j-th column and a second row. Wherein, the sub-pixel units of the first row is one row of the sub-pixel units of a (2k−1)-th row and (2k)-th row, the sub-pixel units of the second row is the other row of the sub-pixel units of (2k−1)-th row sub-pixel units and (2k)-th row. Wherein, each of N, M, I, j, k is a positive integer, i and k are not greater than N/2+1, j is not greater than M.

For understanding, the display panel described above can be resolved as a small block shown in FIG. 3. The small block includes two sub-pixel units, a gate line and two source lines, wherein, the gate line is connected with two sub-pixel units, the two source lines are respectively connected to the two sub-pixel units. In the display panel described above, many small blocks are existed. The specific embodiment method that the two source lines are respectively connected with the two sub-pixel units is not specifically limited. In the small block, one sub-pixel unit corresponds to one source line.

Of course, the connection way of the source line and the sub-pixel unit is regular. For example, in a first way, as shown in FIG. 2, (2j−1)-th source line is respectively connected with sub-pixel units of odd rows of j-th column, and (2j)-th source line is respectively connected with sub-pixel units of even rows of j-th column. Or, in a second way, (2j−1)-th source line is respectively connected with sub-pixel units of even rows of j-th column, and (2j)-th source line is respectively connected with sub-pixel units of odd rows of j-th column. As shown in the small block shown in FIG. 3, the first way indicates that a left side source line and the sub-pixel unit of the first row are electrically connected, and the right side source line and the sub-pixel unit of the second row are electrically connected. The second way indicates that the left side source line and the sub-pixel unit of the second row are electrically connected, and the right side source line and the sub-pixel unit of the first row are electrically connected. It should be noted that all small blocks in the display panel meet the first way and the second way.

In the embodiment of the present invention, because a liquid crystal molecule has a property that the liquid crystal molecule will be damaged if being applied with a fixed voltage for a long time, the polarity inversion of the voltage outputted from the source lines is required to avoid the liquid crystal molecule from being broken. In the polarity inversion process, signal polarities received by a same sub-pixel unit in one frame and a next frame are opposite. The arrangement of the polarities of the sub-pixel unit includes but not limited to: a frame inversion method, a row inversion method, a column inversion method and a dot inversion method. Wherein, after an end of writing of the one frame and before a start of writing of the next frame, for the frame inversion, the voltage polarities stored on the sub-pixel units of whole frame are the same. For the row inversion method, the voltage polarities stored on the sub-pixel units of a same row are the same, and the voltage polarities stored on the sub-pixel units of a next row are the opposite. For the column inversion, the voltage polarities stored on the sub-pixel units of a same column are the same, and the voltage polarities stored on the sub-pixel units of a next column are the opposite. For the dot inversion, for each pixel unit, voltage polarities stored on an above, a below, a left and a right adjacent sub-pixel units are opposite.

Furthermore, the signal polarity outputted from the source lines and the voltage polarity stored on the sub-pixel unit is related. For a column inversion, signal polarity of a (4b+1)-th source line and a (4b+2)-th source line is a first polarity, and signal polarity of a (4b+3)-th source line and a (4b+4)-th source line is a second polarity. For a dot inversion, signal polarity of a (4b+1)-th source line and a (4b+4)-th source line is a first polarity, and signal polarity of a (4b+2)-th source line and a (4b+3)-th source line is a second polarity. Wherein, the first polarity is one of a positive polarity or negative polarity, and the second polarity is the other of the positive polarity or the negative polarity, and b is a non-negative integer not greater than M/2.

In the present embodiment, the sub-pixel unit can include: a thin-film transistor TFT, a liquid crystal capacitor, a storage capacitor. Wherein, the thin-film transistor is used for receiving a control of the output signal of the gate line and receiving the output signal of the source line. The liquid crystal capacitor is used to rotate liquid crystal molecules; the storage capacitor is used to maintain the stored voltage. Furthermore, the color displayed by the sub-pixel unit can be color or black and white, which is not limited here. When the sub-pixel unit is used for displaying three primary colors of red, green and blue, the following arrangements are included but not limited: a (3a+1)-th row sub-pixel unit is a red sub-pixel unit, a (3a+2)-th row sub-pixel unit is a green sub-pixel unit and a (3a+3)-th row sub-pixel unit is a blue sub-pixel unit; a (3a+1)-th row sub-pixel unit is a blue sub-pixel unit, a (3a+2)-th row sub-pixel unit is a green sub-pixel unit and a (3a+3)-th row sub-pixel unit is a red sub-pixel unit; a (3a+1)-th row sub-pixel unit is a red sub-pixel unit, a (3a+2)-th row sub-pixel unit is a blue sub-pixel unit and a (3a+3)-th row sub-pixel unit is a green sub-pixel unit.

It can be understood that in the embodiment of the present invention, the description of the display panel is mainly based on row and column method. If the sub-pixel units are changed in row and column, the gate line and the source line should be adjusted correspondingly, and should be one of the embodiments of the present invention. Besides, the example in the embodiment of the present invention is only used for illustration, and should not be understood as a specific limitation.

For the person skilled in the art, obviously, the present invention is not limited to the detail of the above exemplary embodiment. Besides, without deviating the spirit and the basic feature of the present invention, other specific forms can also achieve the present invention. Therefore, no matter from what point of view, the embodiments should be deemed to be exemplary, not limited. The range of the present invention is limited by the claims not by the above description. Accordingly, the embodiments are used to include all variation in the range of the claims and the equivalent requirements of the claims. It should not regard any reference signs in the claims as a limitation to the claims.

What is claimed is:

1. A display panel, comprising:
multiple sub-pixel units are arranged as an N×M matrix;
a i-th gate line respectively connected to the sub-pixel units of (2i−1)-th row and the sub-pixel units of (2i)-th row, and
a (2j−1)-th source line respectively connected to the sub-pixel units of j-th column and a first row, and a 2j-th source line respectively connected to the sub-pixel units of j-th column and a second row, wherein the sub-pixel units of the first row is one row of the sub-pixel units of a (2k−1)-th row and (2k)-th row, and the sub-pixel units of the second row is the other row of the sub-pixel units of (2k−1)-th row sub-pixel units and (2k)-th row;
wherein each of N, M, I, j, k is a positive integer, i and k are not greater than N/2+1, j is not greater than M.

2. The display panel according to claim 1, wherein the (2j−1)-th source line is respectively connected with the sub-pixel units of odd rows of j-th column, and the (2j)-th source line is respectively connected with the sub-pixel units of even rows of j-th column.

3. The display panel according to claim 1, wherein the (2j−1)-th source line is respectively connected with the sub-pixel units of even rows of j-th column, and the (2j)-th source line is respectively connected with sub-pixel units of odd rows of j-th column.

4. The display panel according to claim 1, wherein each sub-pixel unit of a (3a+1)-th row is a red sub-pixel unit, each sub-pixel unit if a (3a+2)-th row is a green sub-pixel unit and each sub-pixel unit of a (3a+3)-th row sub-pixel unit is a blue sub-pixel unit, wherein a is a non-negative integer not greater than N/3.

5. The display panel according to claim 1, wherein a polarity inversion method of the sub-pixel units includes: a frame inversion method, a row inversion method, a column inversion method and a dot inversion method.

6. The display panel according to claim 4, wherein a signal polarity of a (4b+1)-th source line and a (4b+2)-th source line is a first polarity, and a signal polarity of a (4b+3)-th source line and a (4b+4)-th source line is a second polarity, b is a non-negative integer not greater than M/2.

7. The display panel according to claim 4, wherein a signal polarity of a (4b+1)-th source line and a (4b+4)-th source line is a first polarity, and a signal polarity of a (4b+2)-th source line and a (4b+3)-th source line is a second polarity, b is a non-negative integer not greater than M/2.

8. The display panel according to claim 1, wherein each sub-pixel unit includes a thin-film transistor TFT, a liquid crystal capacitor, a storage capacitor.

9. The display panel according to claim 2, wherein each sub-pixel unit includes a thin-film transistor TFT, a liquid crystal capacitor, a storage capacitor.

10. A display device including a display panel and display device body, wherein display panel comprises:
multiple sub-pixel units are arranged as an N×M matrix;
a i-th gate line respectively connected to the sub-pixel units of (2i−1)-th row and the sub-pixel units of (2i)-th row; and
a (2j−1)-th source line respectively connected to the sub-pixel units of j-th column and a first row, and a 2j-th source line respectively connected to the sub-pixel units of j-th column and a second row, wherein the sub-pixel units of the first row is one row of the sub-pixel units of a (2k−1)-th row and (2k)-th row, and the sub-pixel units of the second row is the other row of the sub-pixel units of (2k−1)-th row sub-pixel units and (2k)-th row;
wherein each of N, M, I, j, k is a positive integer, i and k are not greater than N/2+1, j is not greater than M.

11. The display device according to claim 10, wherein the (2j−1)-th source line is respectively connected with the sub-pixel units of odd rows of j-th column, and the (2j)-th source line is respectively connected with the sub-pixel units of even rows of j-th column.

12. The display device according to claim 10, wherein the (2j−1)-th source line is respectively connected with the sub-pixel units of even rows of j-th column, and the (2j)-th source line is respectively connected with sub-pixel units of odd rows of j-th column.

13. The display device according to claim 10, wherein each sub-pixel unit of a (3a+1)-th row is a red sub-pixel unit, each sub-pixel unit if a (3a+2)-th row is a green sub-pixel unit and each sub-pixel unit of a (3a+3)-th row sub-pixel unit is a blue sub-pixel unit, wherein a is a non-negative integer not greater than N/3.

14. The display device according to claim 10, wherein a polarity inversion method of the sub-pixel units includes: a frame inversion method, a row inversion method, a column inversion method and a dot inversion method.

15. The display device according to claim 13, wherein a signal polarity of a (4b+1)-th source line and a (4b+2)-th source line is a first polarity, and a signal polarity of a (4b+3)-th source line and a (4b+4)-th source line is a second polarity, b is a non-negative integer not greater than M/2.

16. The display device according to claim 13, wherein a signal polarity of a (4b+1)-th source line and a (4b+4)-th source line is a first polarity, and a signal polarity of a (4b+2)-th source line and a (4b+3)-th source line is a second polarity, b is a non-negative integer not greater than M/2.

17. The display device according to claim 10, wherein each sub-pixel unit includes a thin-film transistor TFT, a liquid crystal capacitor, a storage capacitor.

18. The display device according to claim 11, wherein each sub-pixel unit includes a thin-film transistor TFT, a liquid crystal capacitor, a storage capacitor.
